(19) United States
(12) Patent Application Publication
(10) Pub. No.: US 2005/0095485 A1
(43) Pub. Date: May 5, 2005

(54) Fuel cell end plate assembly

(75) Inventors: Kim B. Saulsbury, Lake Elmo, MN (US); Dennis E. Ferguson, Mahtomedi, MN (US); Daniel M. Pierpont, North Saint Paul, MN (US); Dennis P. O'Brien, Maplewood, MN (US); Shane S. Mao, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 10/699,455

(22) Filed: Oct. 31, 2003

(51) Int. Cl. H01M 8/10; H01M 8/00; H01M 2/00; H01M 2/02; H01M 2/08; H01M 2/14

(52) U.S. Cl. 429/32; 429/34; 429/38; 429/39; 429/35

(57) ABSTRACT

Fuel cell systems incorporate end plate assemblies used to compress the fuel cell stack and/or to collect current from the fuel cell stack. A fuel cell system includes a fuel cell stack having fuel cells stacked in a predetermined stacking direction. Multi-function or multi-region compression end plate assemblies are disposed at the ends of a fuel cell stack. A multi-region compression end plate assembly involves compression mechanisms configured to preferentially compress separate areas of the fuel cell stack. A multi-function end plate assembly employs a current collector passing through an end plate to collect current from the fuel cell stack. The current collector may be used to preferentially compress a region of the fuel cell stack.

### FIELD OF THE INVENTION

The present invention relates generally to fuel cells and, more particularly, to a fuel cell end plate assembly.

### BACKGROUND OF THE INVENTION

A typical fuel cell system includes a power section in which one or more fuel cells generate electrical power. A fuel cell is an energy conversion device that converts hydrogen and oxygen into water, producing electricity and heat in the process. Each fuel cell unit may include a proton exchange member at the center with gas diffusion layers on either side of the proton exchange member. Anode and cathode layers are respectively positioned at the outside of the gas diffusion layers.

The reaction in a single fuel cell typically produces less than one volt. A plurality of the fuel cells may be stacked and electrically connected in series to achieve a desired voltage. Electrical current is collected from the fuel cell stack and used to drive a load. Fuel cells may be used to supply power for a variety of applications, ranging from automobiles to laptop computers.

The efficacy of the fuel cell power system depends in part on the integrity of the various contacting and sealing interfaces within individual fuel cells and between adjacent fuel cells of the stack. Such contacting and sealing interfaces include those associated with the transport of fuels, coolants, and effluents within and between fuel cells of the stack.

There is a need for devices that facilitate compression of the fuel cell stack. There is a further need for systems that provide effective electrical current collection from fuel cell stacks. The present invention fulfills these and other needs.

### SUMMARY OF THE INVENTION

The present invention involves fuel cell systems incorporating end plate assemblies for compressing the fuel cell stack and/or collecting current from the fuel cell stack. According to one embodiment, a fuel cell current collection system includes a fuel cell stack comprising fuel cells stacked in a predetermined stacking direction. The fuel cell current collection system further comprises an end plate assembly disposed at one end of the fuel cell stack and a current collector passing through the end plate. The current collector is electrically coupled to the fuel cell stack and is configured to collect current from the fuel cell stack.

According to another embodiment of the invention, a fuel cell assembly includes a fuel cell stack comprising fuel cells arranged in a predetermined stacking direction; and a compression apparatus including two or more compression mechanisms. Each of the compression mechanisms is configured to preferentially compress a separate region of the fuel cell stack.

In yet another embodiment of the invention, a fuel cell system includes fuel cells arranged in a predetermined stacking direction and a compression apparatus. The compression apparatus includes compression mechanisms configured to preferentially compress separate regions of the fuel cell stack. One of the compression mechanisms involves a current collection/compression mechanism that is configured to preferentially compress a first region of the fuel cell stack and to collect current from the fuel cell stack.

In yet another embodiment of the invention, a fuel cell compression apparatus includes a fuel cell end plate. The fuel cell end plate comprises a frame and a structural element at least partially covering the frame.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

FIG. 1a is an illustration of a fuel cell and its constituent layers;

FIG. 1b illustrates a unitized cell assembly having a monopolar configuration in accordance with an embodiment of the present invention;

FIG. 1c illustrates a unitized cell assembly having a monopolar/bipolar configuration in accordance with an embodiment of the present invention;

FIG. 2 is a fuel cell assembly in accordance with embodiments of the invention;

FIGS. 3a-3b illustrate a fuel cell current collection system in accordance with embodiments of the invention;

FIGS. 4a-4e illustrate fuel cell current collection system involving one or more current collecting plates in accordance with embodiments of the invention;

FIG. 5 is a diagram illustrating preferential compression of multiple regions of a fuel cell stack in accordance with embodiments of the invention;

FIG. 6 illustrates a dual-region compression mechanism with current collection functionality in accordance with embodiments of the invention;

FIG. 7 illustrates an end plate in accordance with embodiments of the invention;

FIGS. 8a-8d illustrate a dual region compression mechanism in accordance with embodiments of the invention;

FIG. 9 is an illustrative depiction of a simplified fuel cell stack that facilitates an understanding of fuel cell operation in accordance with the principles of the present invention; and

FIGS. 10-13 illustrate fuel cell systems within which one or more fuel cell stacks employing compression mechanisms and/or current collection systems of the present invention can be employed.

While the invention is amenable to various modifications and alternative forms, specifics thereof have been shown by way of example in the drawings and will be described in detail. It is to be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF VARIOUS EMBODIMENTS

In the following description of the illustrated embodiments, reference is made to the accompanying drawings which form a part hereof, and in which is shown by way of illustration, various embodiments in which the invention may be practiced. It is to be understood that the embodiments may be utilized and structural changes may be made without departing from the scope of the present invention.

The present invention involves fuel cell systems incorporating end plate assemblies for compressing the fuel cell stack and/or collecting current from the fuel cell stack. Various embodiments of the invention are directed to multi-function end plates and/or multi-region compression assemblies. In accordance with one approach, an end plate assembly providing multi-region compression functionality includes two or more compression mechanisms that operate to preferentially compress separate regions of the fuel cell stack.

In accordance with another approach, a multi-function end plate assembly provides an electrical connection mechanism allowing current collection from the fuel cell stack. The electrical connection mechanism may also function as a compression mechanism, used for preferentially compressing an inner region of the fuel cell stack.

In various embodiments, the end plate assembly may include an end plate comprising multiple structural elements. For example, the end plate may include a frame structure formed of one material with a second material disposed within the frame members and/or covering the frame.

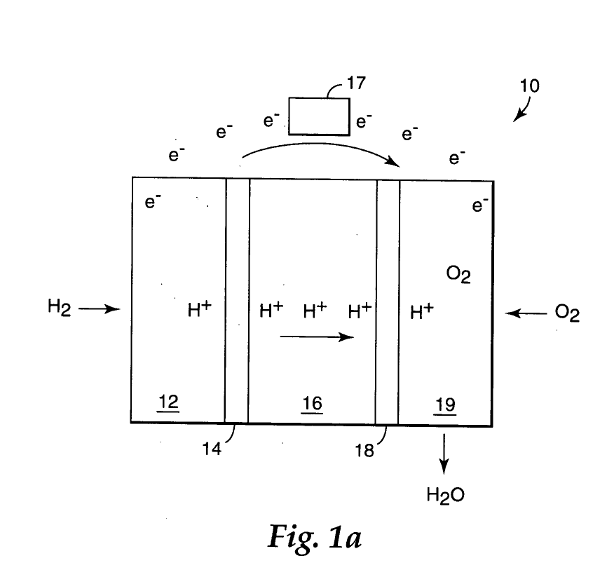

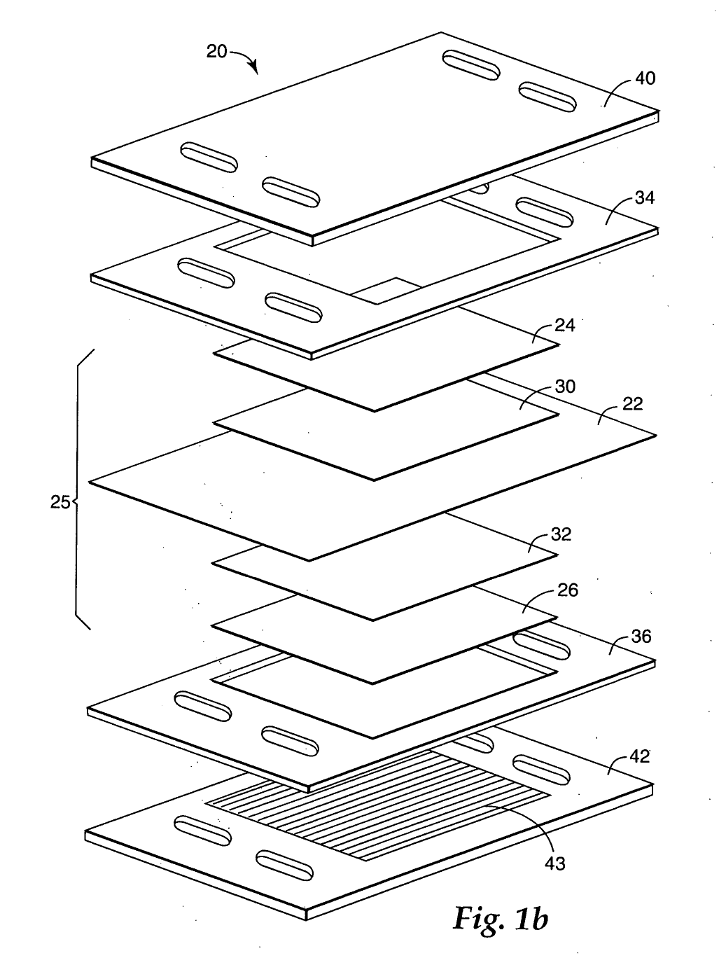

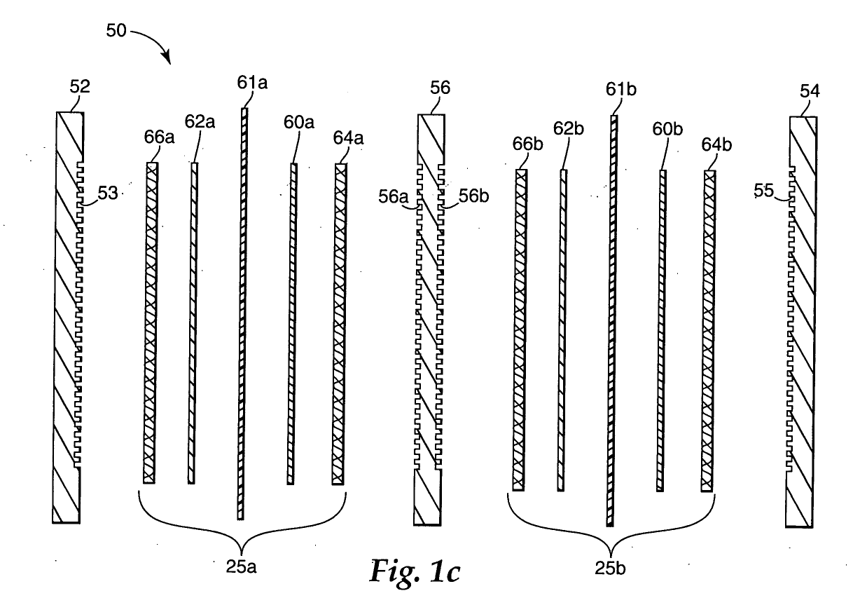

A typical fuel cell is depicted in FIG. 1a. A fuel cell is an electrochemical device that combines hydrogen fuel and oxygen from the air to produce electricity, heat, and water. Fuel cells do not utilize combustion, and as such, fuel cells produce little if any hazardous effluents. Fuel cells convert hydrogen fuel and oxygen directly into electricity, and can be operated at much higher efficiencies than internal combustion electric generators, for example.

The fuel cell 10 shown in FIG. 1a includes a first fluid transport layer (FTL) 12 adjacent an anode 14. Adjacent the anode 14 is an electrolyte membrane 16. A cathode 18 is situated adjacent the electrolyte membrane 16, and a second fluid transport layer 19 is situated adjacent the cathode 18. In operation, hydrogen fuel is introduced into the anode portion of the fuel cell 10, passing through the first fluid transport layer 12 and over the anode 14. At the anode 14, the hydrogen fuel is separated into hydrogen ions (H⁺) and electrons (e⁻).

The electrolyte membrane 16 permits only the hydrogen ions or protons to pass through the electrolyte membrane 16 to the cathode portion of the fuel cell 10. The electrons cannot pass through the electrolyte membrane 16 and, instead, flow through an external electrical circuit in the form of electric current. This current can power an electric load 17, such as an electric motor, or be directed to an energy storage device, such as a rechargeable battery.

Oxygen flows into the cathode side of the fuel cell 10 via the second fluid transport layer 19. As the oxygen passes over the cathode 18, oxygen, protons, and electrons combine to produce water and heat.

Individual fuel cells, such as that shown in FIG. 1a, can be packaged as unitized fuel cell assemblies as described below. The unitized fuel cell assemblies, referred to herein as unitized cell assemblies (UCAs), can be combined with a number of other UCAs to form a fuel cell stack. The UCAs may be electrically connected in series with the number of UCAs within the stack determining the total voltage of the stack, and the active surface area of each of the cells determines the total current. The total electrical power generated by a given fuel cell stack can be determined by multiplying the total stack voltage by total current.

A number of different fuel cell technologies can be employed to construct UCAs in accordance with the principles of the present invention. For example, a UCA packaging methodology of the present invention can be employed to construct proton exchange membrane (PEM) fuel cell assemblies. PEM fuel cells operate at relatively low temperatures (about 175° F./80° C.), have high power density, can vary their output quickly to meet shifts in power demand, and are well suited for applications where quick startup is required, such as in automobiles for example.

The proton exchange membrane used in a PEM fuel cell is typically a thin plastic sheet that allows hydrogen ions to pass through it. The membrane is typically coated on both sides with highly dispersed metal or metal alloy particles (e.g., platinum or platinum/ruthenium) that are active catalysts. The electrolyte used is typically a solid perfluorinated sulfonic acid polymer. Use of a solid electrolyte is advantageous because it reduces corrosion and management problems.

Hydrogen is fed to the anode side of the fuel cell where the catalyst promotes the hydrogen atoms to release electrons and become hydrogen ions (protons). The electrons travel in the form of an electric current that can be utilized before it returns to the cathode side of the fuel cell where oxygen has been introduced. At the same time, the protons diffuse through the membrane to the cathode, where the hydrogen ions are recombined and reacted with oxygen to produce water.

A membrane electrode assembly (MEA) is the central element of PEM fuel cells, such as hydrogen fuel cells. As discussed above, typical MEAs comprise a polymer electrolyte membrane (PEM) (also known as an ion conductive membrane (ICM)), which functions as a solid electrolyte.

One face of the PEM is in contact with an anode electrode layer and the opposite face is in contact with a cathode electrode layer. Each electrode layer includes electrochemical catalysts, typically including platinum metal. Fluid transport layers (FTLs) facilitate gas transport to and from the anode and cathode electrode materials and conduct electrical current.

In a typical PEM fuel cell, protons are formed at the anode via hydrogen oxidation and transported to the cathode to react with oxygen, allowing electrical current to flow in an external circuit connecting the electrodes. The FTL may also be called a gas diffusion layer (GDL) or a diffuser/current collector (DCC). The anode and cathode electrode layers may be applied to the PEM or to the FTL during manufacture, so long as they are disposed between PEM and FTL in the completed MEA.

Any suitable PEM may be used in the practice of the present invention. The PEM typically has a thickness of less than 50 μm, more typically less than 40 μm, more typically less than 30 μm, and most typically about 25 μm. The PEM is typically comprised of a polymer electrolyte that is an acid-functional fluoropolymer, such as Nafion® (DuPont Chemicals, Wilmington Del.) and Flemion® (Asahi Glass Co. Ltd., Tokyo, Japan). The polymer electrolytes useful in the present invention are typically preferably copolymers of tetrafluoroethylene and one or more fluorinated, acid-functional comonomers.

Typically, the polymer electrolyte bears sulfonate functional groups. Most typically, the polymer electrolyte is Nafion®. The polymer electrolyte typically has an acid equivalent weight of 1200 or less, more typically 1100, and most typically about 1000.

Any suitable FTL may be used in the practice of the present invention. Typically, the FTL is comprised of sheet material comprising carbon fibers. The FTL is typically a carbon fiber construction selected from woven and non-woven carbon fiber constructions. Carbon fiber constructions which may be useful in the practice of the present invention may include: Toray Carbon Paper, SpectraCarb Carbon Paper, AFN non-woven carbon cloth, Zoltek Carbon Cloth, and the like. The FTL may be coated or impregnated with various materials, including carbon particle coatings, hydrophilizing treatments, and hydrophobizing treatments such as coating with polytetrafluoroethylene (PTFE).

Any suitable catalyst may be used in the practice of the present invention. Typically, carbon-supported catalyst particles are used. Typical carbon-supported catalyst particles are 50-90% carbon and 10-50% catalyst metal by weight, the catalyst metal typically comprising Pt for the cathode and Pt and Ru in a weight ratio of 2:1 for the anode. The catalyst is typically applied to the PEM or to the FTL in the form of a catalyst ink. The catalyst ink typically comprises polymer electrolyte material, which may or may not be the same polymer electrolyte material which comprises the PEM.

The catalyst ink typically comprises a dispersion of catalyst particles in a dispersion of the polymer electrolyte. The ink typically contains 5-30% solids (i.e. polymer and catalyst) and more typically 10-20% solids. The electrolyte dispersion is typically an aqueous dispersion, which may additionally contain alcohols, polyalcohols, such a glycerin and ethylene glycol, or other solvents such as N-methylpyrrolidone (NMP) and dimethylformamide (DMF). The water, alcohol, and polyalcohol content may be adjusted to alter rheological properties of the ink. The ink typically contains 0-50% alcohol and 0-20% polyalcohol. In addition, the ink may contain 0-2% of a suitable dispersant. The ink is typically made by stirring with heat followed by dilution to a coatable consistency.

The catalyst may be applied to the PEM or the FTL by any suitable means, including both hand and machine methods, including hand brushing, notch bar coating, fluid bearing die coating, wire-wound rod coating, fluid bearing coating, slot-fed knife coating, three-roll coating, or decal transfer. Coating may be achieved in one application or in multiple applications.

Direct methanol fuel cells (DMFC) are similar to PEM cells in that they both use a polymer membrane as the electrolyte. In a DMFC, however, the anode catalyst itself draws the hydrogen from liquid methanol fuel, eliminating the need for a fuel reformer. DMFCs typically operate at a temperature between 120-190° F./49-88° C. A direct methanol fuel cell can be subject to UCA packaging in accordance with the principles of the present invention.

Referring now to FIG. 1b, there is illustrated an embodiment of a UCA implemented in accordance with a PEM fuel cell technology. As is shown in FIG. 1b, a membrane electrode assembly (MEA) 25 of the UCA 20 includes five component layers. A PEM layer 22 is sandwiched between a pair of fluid transport layers 24 and 26, such as diffuse current collectors (DCCs) or gas diffusion layers (GDLs) for example. An anode 30 is situated between a first FTL 24 and the membrane 22, and a cathode 32 is situated between the membrane 22 and a second FTL 26.

In one configuration, a PEM layer 22 is fabricated to include an anode catalyst coating 30 on one surface and a cathode catalyst coating 32 on the other surface. This structure is often referred to as a catalyst-coated membrane or CCM. According to another configuration, the first and second FTLs 24, 26 are fabricated to include an anode and cathode catalyst coating 30, 32, respectively. In yet another configuration, an anode catalyst coating 30 can be disposed partially on the first FTL 24 and partially on one surface of the PEM 22, and a cathode catalyst coating 32 can be disposed partially on the second FTL 26 and partially on the other surface of the PEM 22.

The FTLs 24, 26 are typically fabricated from a carbon fiber paper or non-woven material or woven cloth. Depending on the product construction, the FTLs 24, 26 can have carbon particle coatings on one side. The FTLs 24, 26, as discussed above, can be fabricated to include or exclude a catalyst coating.

In the particular embodiment shown in FIG. 1b, MEA 25 is shown sandwiched between a first edge seal system 34 and a second edge seal system 36. Adjacent the first and second edge seal systems 34 and 36 are flow field plates 40 and 42, respectively. Each of the flow field plates 40, 42 includes a field of gas flow channels 43 and ports through which hydrogen and oxygen feed fuels pass. In the configuration depicted in FIG. 1b, flow field plates 40, 42 are configured as monopolar flow field plates, in which a single MEA 25 is sandwiched there between. The flow field in this and other embodiments may be a low lateral flux flow field as disclosed in co-pending application Ser. No. 09/954,601, filed Sep. 17, 2001, and incorporated herein by reference.

The edge seal systems 34, 36 provide the necessary sealing within the UCA package to isolate the various fluid (gas/liquid) transport and reaction regions from contaminating one another and from inappropriately exiting the UCA 20, and may further provide for electrical isolation and hard stop compression control between the flow field plates 40, 42. The term “hard stop” as used herein generally refers to a nearly or substantially incompressible material that does not significantly change in thickness under operating pressures and temperatures. More particularly, the term “hard stop” refers to a substantially incompressible member or layer in a membrane electrode assembly (MEA) which halts compression of the MEA at a fixed thickness or strain. A “hard stop” as referred to herein is not intended to mean an ion conducting membrane layer, a catalyst layer, or a gas diffusion layer.

In one configuration, the edge seal systems 34, 36 include a gasket system formed from an elastomeric material. In other configurations, as will be described below, one, two or more layers of various selected materials can be employed to provide the requisite sealing within UCA 20. Other configurations employ an in-situ formed seal system.

FIG. 1c illustrates a UCA 50 which incorporates multiple MEAs 25 through employment of one or more bipolar flow field plates 56. In the configuration shown in FIG. 1c, UCA 50 incorporates two MEAs 25a and 25b and a single bipolar flow field plate 56. MEA 25a includes a cathode 62a/membrane 61a/anode 60a layered structure sandwiched between FTLs 66a and 64a. FTL 66a is situated adjacent a flow field end plate 52, which is configured as a monopolar flow field plate. FTL 64a is situated adjacent a first flow field surface 56a of bipolar flow field plate 56.

Similarly, MEA 25b includes a cathode 62b/membrane 61b/anode 60b layered structure sandwiched between FTLs 66b and 64b. FTL 64b is situated adjacent a flow field end plate 54, which is configured as a monopolar flow field plate. FTL 66b is situated adjacent a second flow field surface 56b of bipolar flow field plate 56. It will be appreciated that N number of MEAs 25 and N−1 bipolar flow field plates 56 can be incorporated into a single UCA 50. It is believed, however, that, in general, a UCA 50 incorporating one or two MEAs 56 (N=1, bipolar plates=0 or N=2, bipolar plates=1) is preferred for more efficient thermal management.

The UCA configurations shown in FIGS. 1b and 1c are representative of two particular arrangements that can be implemented for use in the context of the present invention. These two arrangements are provided for illustrative purposes only, and are not intended to represent all possible configurations coming within the scope of the present invention. Rather, FIGS. 1b and 1c are intended to illustrate various components that can be selectively incorporated into a unitized fuel cell assembly packaged in accordance with the principles of the present invention.

By way of further example, a variety of sealing methodologies can be employed to provide the requisite sealing of a UCA comprising a single MEA disposed between a pair of monopolar flow field plates, and can also be employed to seal a UCA comprising multiple MEAs, a pair of monopolar flow field plates and one or more bipolar flow field plates. For example, a UCA having a monopolar or bipolar structure can be constructed to incorporate an in-situ formed solid gasket, such as a flat solid silicone gasket.

In particular embodiments, a UCA, in addition to including a sealing gasket, can incorporate a hard stop arrangement. The hard stop(s) can be built-in, disposed internal to the UCA, or integrated into the monopolar and/or bipolar flow field plates. Other features can be incorporated into a UCA, such as an excess gasket material trap channel and a micro replicated pattern provided on the flow field plates. Incorporating a hard stop into the UCA packaging advantageously limits the amount of compressive force applied to the MEA during fabrication (e.g., press forces) and during use (e.g., external stack pressure system). For example, the height of a UCA hard stop can be calculated to provide a specified amount of MEA compression, such as 30%, during UCA construction, such compression being limited to the specified amount by the hard stop. Incorporating a hard stop into the flow field plates can also act as a registration aid for the two flow field plates. Accordingly, a fuel cell assembly of the present invention is not limited to a specific UCA configuration.

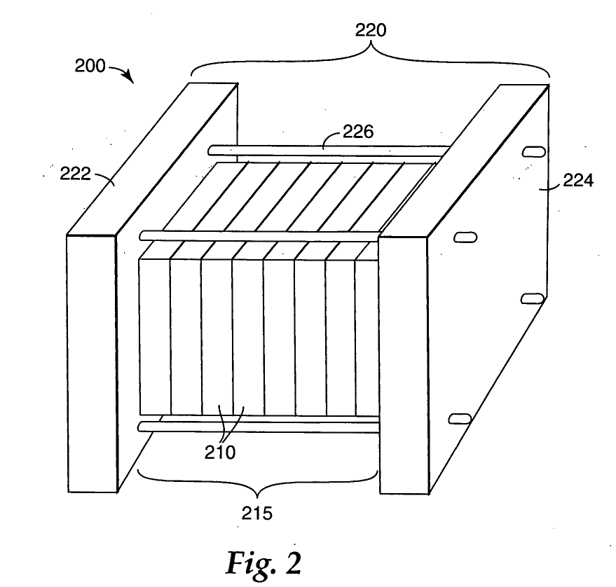

FIG. 2 illustrates a fuel cell assembly 200 including multiple UCAs 210 arranged to form a fuel cell stack 215. According to this implementation, the stack 215 of UCAs 210 is compressed using a compression apparatus 220 including end plates 222, 224, disposed at opposite ends of the fuel cell stack 215, and rods 226 connecting the end plates 222, 224. The compression apparatus 220 may comprise multi-region compression mechanisms and/or a multi-function end plate assembly in accordance with embodiments of the invention as described below. The end plates 222, 224 may be formed of multiple materials in accordance with further embodiments described below.

In a conventional fuel cell system design, the main purpose of the end plates is to provide a means for physically containing the UCAs in a specific packaging arrangement and to provide for mechanical compression of the UCAs in the stack. Conventional end plates have typically been manufactured from conductive metals, selected mainly for their strength. However, the thermal and electrical properties of metallic end plates may produce undesirable effects. For example, metallic end plates may produce thermal gradients across the fuel cell stack and/or may result in electrical short circuits between components of the fuel cell assembly. Additional electrically and/or thermally insulating parts may be required to avoid or reduce these effects.

Current collection from the stack is preferably accomplished without losses due to shorts through the end plate and/or other components of the compression apparatus. Further, for effective operation, a seal must be maintained between current collection components and the fuel cell gases and coolant. In a typical stack design, the current collection components are disposed between the end plate and the active cells. Thus, electrically insulating the current collection components from a metallic end plate and sealing the current collection components from gases and coolants presents a challenge.

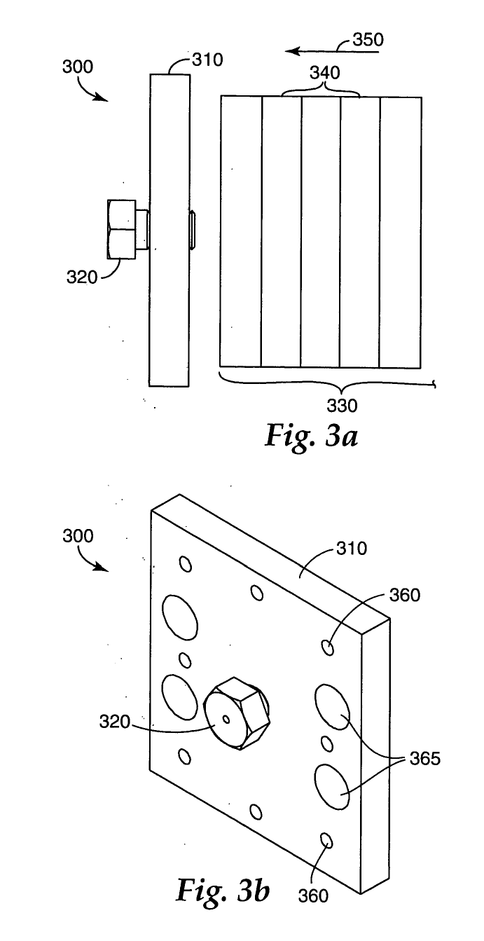

Embodiments of the invention are directed to systems and methods for collecting current from the fuel cell stack. FIG. 3a illustrates a side view of one embodiment of a current collection system 300 in accordance with one embodiment. A plurality of UCAs 340 are stacked in a predetermined stacking direction 350 to form a fuel cell stack 330. The current collection system 300 includes an end plate 310 that may be used in conjunction with additional compression apparatus components, e.g., tie rods or other connecting members, for compressing the fuel cell stack 330.

In a preferred embodiment, the end plate 310 is formed of an electrically and thermally insulating material, such as G-11 glass cloth and epoxy resin (Accurate Plastics, Inc., Yonkers, N.Y.). The use of such material provides strength for adequate compression without excessive deformation of the end plates and also allows a relatively compact end plate configuration. Using G-11 glass/epoxy, or a material having similar properties, the end plate may be formed having a flexural strength of about 57,000 psi and a modulus of elasticity of about 2.5×10⁶, for example.

The end plate 310 in accordance with this embodiment provides electrical insulation from the fuel cell stack 330 permitting direct contact of the end plate material with fuel cell active areas without fear of voltage drops and power losses. The volume resistivity of the end plate material may be about 5×10⁶ megaohms×cm, with a surface resistivity of about 1.5×10⁶ megaohms/square, for example.

Further, the use of G-11 or similar material produces an end plate 310 that is a good thermal insulator. Thermally conductive end plates, e.g., metallic end plates, may produce significant temperature gradients between the center UCA and the UCAs at the ends of the stack. The thermally insulating end plate 310 in accordance with embodiments of the invention reduces thermal gradients across the fuel cell stack 330 and allows direct contact between the end plates 310 and the bipolar plates. Reduction of thermal gradients across the stack through the use of a thermally insulating end plate material improves fuel cell system operation and reduces cost of the fuel cell system.

The current collection system 300 further includes a current collector 320, illustrated in FIG. 3a as a bolt, that passes through the end plate 310 and electrically couples to the UCA 340 positioned at the end of the stack 330 and adjacent the end plate 310. In one embodiment, the current collector 320 is oriented substantially longitudinally with respect to the stacking direction 350.

Although the current collector 320 is illustrated in FIG. 3a as a single bolt, other current collector configurations are possible and are considered to be within the scope of the invention. For example, the current collector 320 may be implemented as one or a plurality of bolts, pins, rods, or other structures extending through the electrically non-conducting end plate 310.

FIG. 3b shows an isometric view of the current collection system 300. The end plate 310 may include a number of holes 360 through which connecting rods of a compression apparatus may be inserted to effect compression of the fuel cell stack. The end plate 310 may further include one or more holes 365 adapted to receive gas fittings. The current collector 320 may be positioned in a central region of the end plate 310, or may be positioned at any location that effectively collects current from the fuel cell stack.

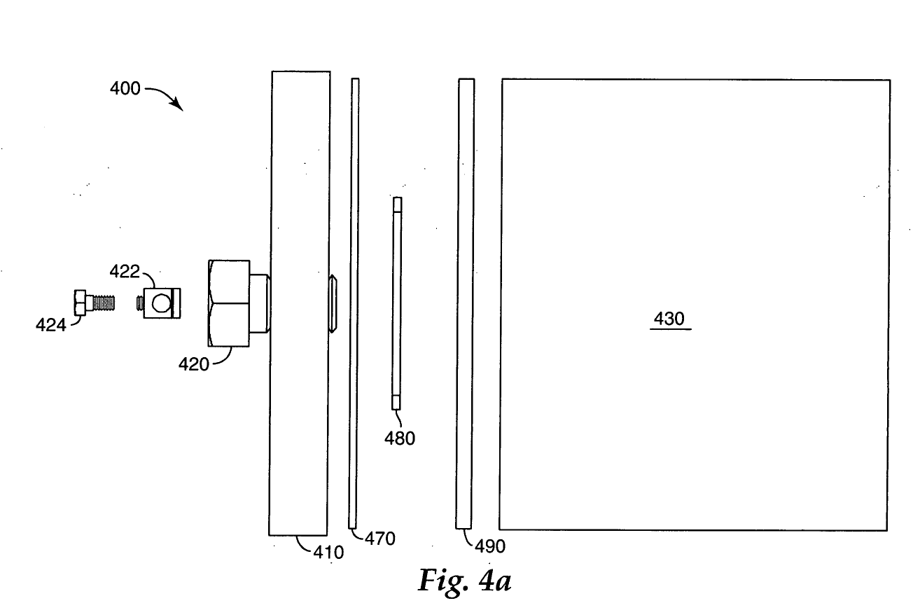

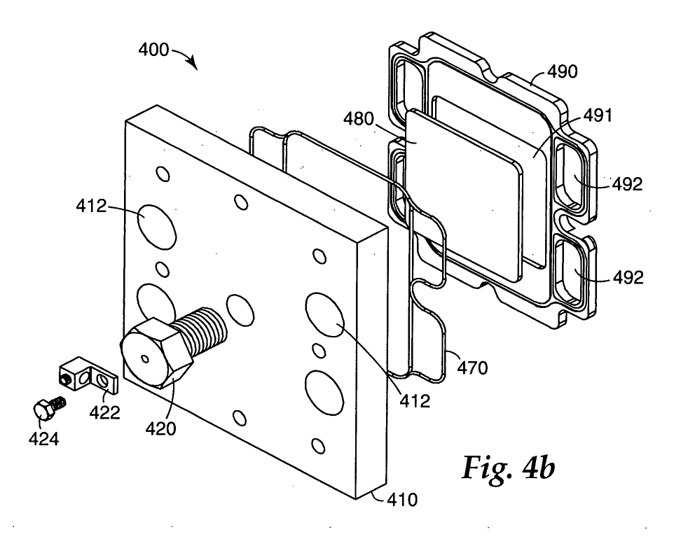

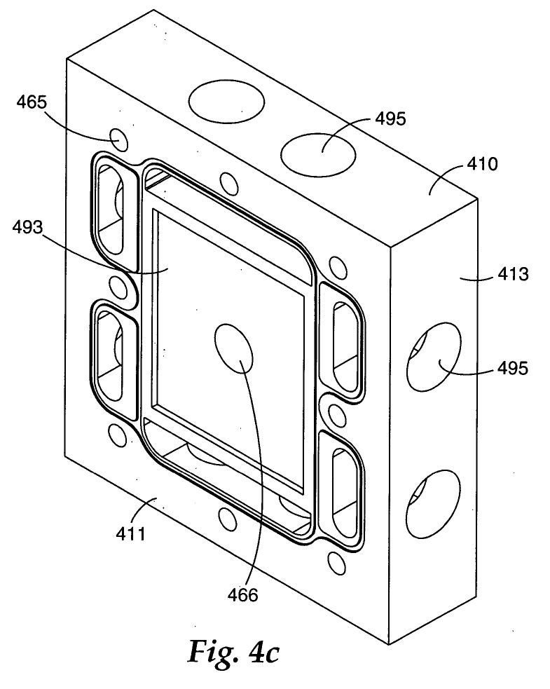

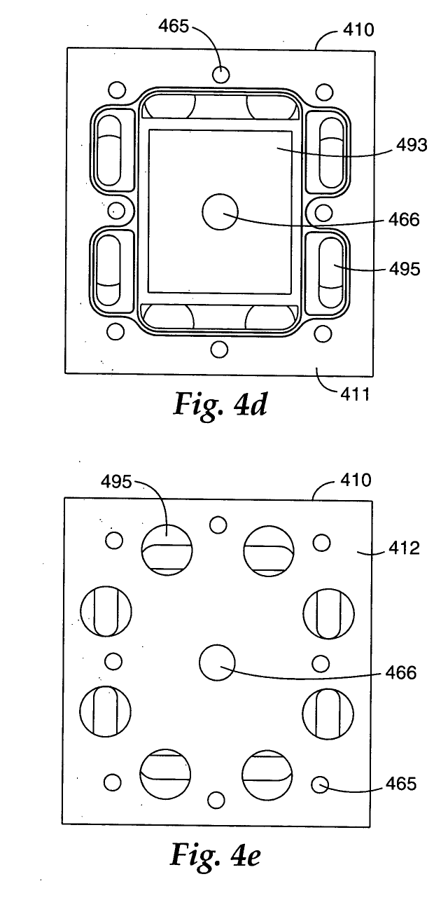

FIGS. 4a and 4b, respectively, show side and isometric views of a current collection system 400 in accordance with an embodiment of the invention. The system 400 includes an end plate 410 formed of an electrically and thermally insulating material as described in connection with FIGS. 3a and 3b above.

A current collector 420, illustrated as a bolt in FIGS. 4a and 4b, extends through the end plate 410. The end plate 410 may be used in conjunction with additional compression mechanisms, e.g., tie rods or other connecting members, for compressing the fuel cell stack 430. One or more additional current collecting plates 480 may be positioned between the last flow field plate 490 and the end plate 410 to enhance current collection as described below. A seal 470 may be positioned between the last flow field plate 490 and the end plate 410 to block gas and coolant leads at the interface of the end plate 410 between the last flow field plate 490.

As illustrated in FIG. 4b, the last flow field plate 490 of the fuel cell stack 430 may include a recessed pocket 491 for receiving a current collecting plate 480. The current collecting plate 480 may be formed of a metallic material such as copper, for example. Current from active cells within the stack 430 (FIG. 4a) pass through the last flow field plate 490 to the current collecting plate 480. Current is removed from the current collecting plate 480 via the current collector 420, illustrated as a bolt in FIGS. 4a and 4b. The current collection bolt 420 passes through the end plate 410 to contact the current collecting plate 480. The high resistivity of the end plate material prevents excessive current losses at the end plate 410. The head of the current collector bolt 420 may be drilled and tapped to accept a bolt 424, e.g., a standard %-20 bolt, that may be used to secure a high current terminal 422.

FIGS. 4c-4e illustrate additional embodiments of an end plate assembly for facilitating current collection from the fuel cell stack. FIGS. 4c-4e illustrate end plates incorporating a recess 493 for receiving a current collecting plate 480 (FIGS. 4a and 4b).

As previously described, the current collecting plate may be formed of copper or other metallic material. As illustrated in FIGS. 4c-e, the recess 493 in the end plate 410 may be configured to receive the current collecting plate so that the surface of the current collecting plate is flush with the surface of the fuel cell at the end of the fuel cell stack.

The end plate 410 may include, for example, a number of manifold ports 495. The manifold ports 495 may have a substantially circular shape at the outside 412 (FIG. 4e) or side 413 (FIG. 4c) of the end plate 410 to accept circular fittings. The manifold ports 495 may have a non-circular shape at the inside 411 (FIGS. 4c and 4d) of the end plate 410 to provide compatibility with non-circular manifold ports of the flow field plates (not shown).

The end plate 410 may also include a number of holes 465 configured to accept connecting rods of a compression apparatus. In addition, the end plate 410 may include a centrally located hole 466, e.g., a threaded hole configured to accommodate a current collector bolt as described above. A seal may be positioned adjacent the end plate 410, for example, in a groove 471 or other appropriate feature formed in the end plate 410. The seal blocks gas and coolant leaks at the interface of the end plate 410 and the first fuel cell of the fuel cell stack.

The end plate 410 of FIG. 4c includes circular gas and/or coolant ports 495 at one or more sides 413 of the end plate 410. FIGS. 4d-4e illustrates front and back views of an end plate 410 including a recess 493 for a current collecting plate. The end plate 410 of FIGS. 4d-4e includes circular gas and/or inlet ports 495 at the outer surface 412 of the end plate 410.

As previously described, the fuel cell stack is compressed by a compression apparatus to seal the gas and coolant manifolds. The fuel cell stack 215, as illustrated in FIG. 2, may be compressed using a compression apparatus 220 employing connecting rods 226 or other connecting components that pass through and/or mechanically couple to the end plates 222, 224. Generally, it is undesirable to pass connecting apparatus, e.g., connecting rods 226, through the active area of the UCAs in the fuel cell stack. Such a configuration presents additional sealing requirements and other complications.

To avoid connecting apparatus passing through the active areas of the stack 215, the compression hardware, e.g., connecting rods 226, may be moved to the peripheral regions of the end plates 222, 224, thus avoiding the active areas of the UCAs 210. However, when compression hardware is located at the periphery beyond the active areas, it becomes more difficult to distribute the force evenly across the bipolar plates. In this situation, the outer edges of the end plates 222, 224 may flex and pull in, while the center of the plate will bow outward in the opposite direction. Although this produces good pressure at the outer edges of the UCAs 210, there may be inadequate pressure at the center. Although the thickness of the end plate may be increased to avoid bowing, this constraint may render the end plate undesirably thick, heavy, and/or expensive.

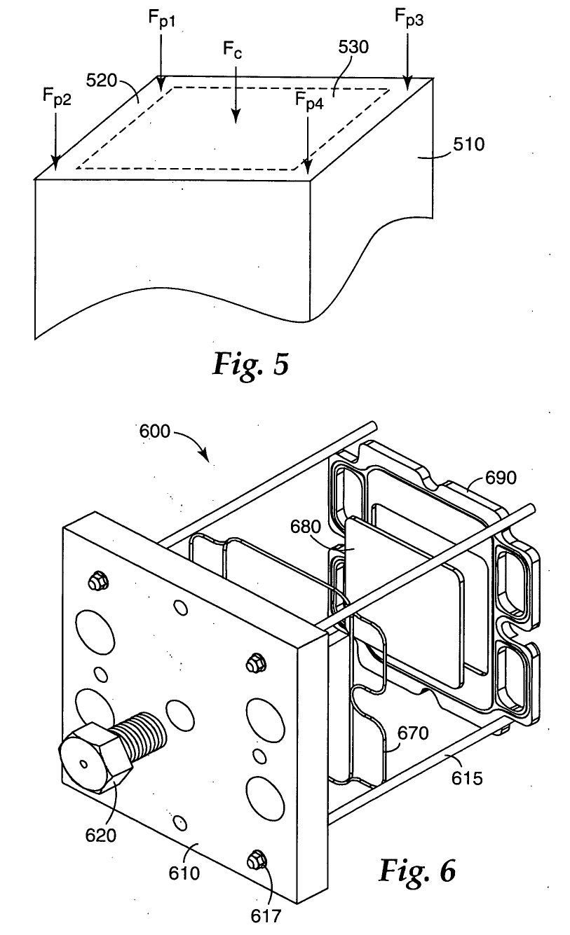

In accordance with embodiments of the invention, a multi-region compression assembly may be implemented to preferentially compress multiple regions of the fuel cell stack. In various embodiments, a dual region compression assembly may include first and second compression mechanisms employed to preferentially compress separate regions of the fuel cell stack. For example, as illustrated in FIG. 5, a first compression mechanism may be used to exert forces Fp₁, Fp₂, Fp₃, Fp₄, in a peripheral region 520 of a fuel cell stack 510. A second compression mechanism may be used to exert a force F_{c} in a central region 530 of the fuel cell stack 510. Such a dual region compression system may include a first compression mechanism to preferentially provide mechanical compression of a first zone including the peripheral seal regions of the internal manifolding of the fuel cell stack. A separate and independently activatable compression mechanism may be used to provide mechanical compression of a second zone including the centrally positioned active areas.

In one implementation, illustrated in FIG. 6, the first compression mechanism comprises a number of connecting rods 615, such as threaded tie rods, inserted through holes in peripheral regions of one or both of the end plates 610 of a fuel cell assembly. Nuts 617 disposed on threaded connection rods 615 may be employed to produce forces at the edges of the end plate 610 to preferentially compress the peripheral edges of the fuel cell stack (not shown in FIG. 6).

The second compression mechanism may be implemented using a bolt 620 or other structure inserted through the end plate 610. The bolt 620 may be tightened, producing a force to preferentially compress a central region of the fuel cell stack. The bolt 620 may additionally be used to collect current from the fuel cell stack as previously described. The end plate 610 may be formed of a non-conductive material. The fuel cell assembly may additionally include a last flow field plate 690, current collecting plate 680, and seal 670 as previously described.

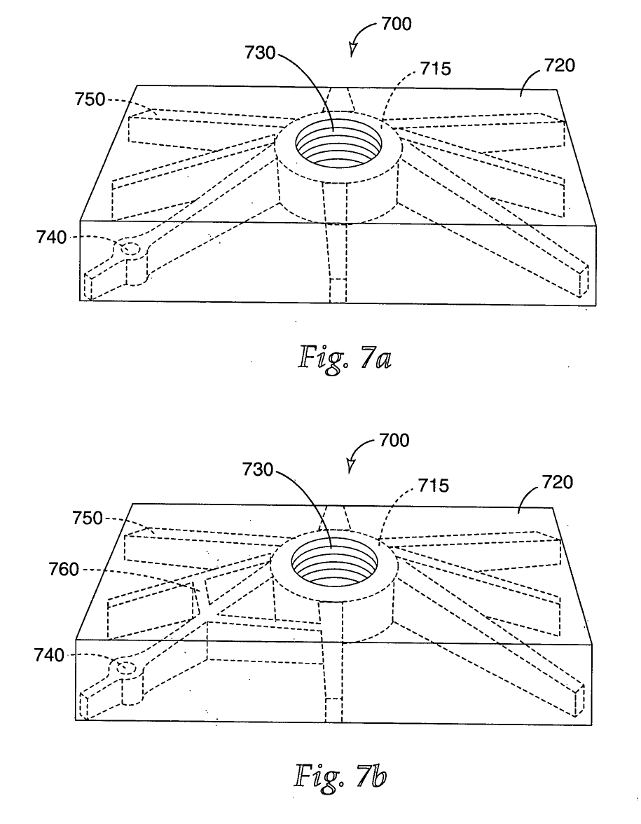

The end plate 700 illustrated in FIG. 7 may be used in an end plate assembly configured for current collection and/or multi-region compression according to various embodiments of the invention. In this example, the end plate 700 is formed of two materials. A first material, e.g., a metallic material, is used to form an end plate frame 715. A second material, e.g., a plastic, at least partially covers the frame and/or is disposed within the frame members.

The frame 715 may be formed of a relatively high modulus of elasticity material in a shape that facilitates carrying the compressive load on the end plate 700. In the implementations illustrated in FIGS. 7a and 7b, the frame 715 is a star-shaped structure with radial frame members 750 extending from a central region. The end plate shown in FIG. 7b includes one or more web members 760 extending between the radial frame members 750. Other frame shapes are also possible. The frame 715 may be made of a metallic material, such as aluminum, steel, or other metallic or non-metallic material. A metallic frame is less subject to creep when compared to a frame or end plate made of exclusively plastic, for example. Further, because creep data on plastics is limited, creep of a metal frame is more predictable.

The frame 715 may be formed by several methods, including die-cast, sand cast, forged or stamped. A threaded hole 730 in a central region of the frame 715 may be provided for a current collector/compression bolt extending through the frame 715 as described above. The threaded hole 730 may be cast in, machined in, or inserted, for example.

The end plate 700 may also include a number of holes 740 allowing the connecting rods of a compression apparatus to extend through the end plate 700. Inserting the compression rods through the frame 715 allows the compressive load to be transferred directly to the frame 715. The holes 740, 730 may be electrically insulated to prevent electrical connection with the current collector bolt.

A second structure 720, formed of a material having a lower modulus in comparison to the frame material, may be used to cover portions of the frame 715. The second material may be, for example, a moldable thermoplastic or thermoset material. The frame 715 may be insert-molded into the second material. The second material may be used to provide a non-conductive external covering for a metallic frame 715. A multiple material end plate 700 comprising a metal frame embedded in plastic, for example, may provide thermal and electrical insulation in addition to reduction in weight and/or size over conventional end plates.

Another embodiment of the invention involves a dual end plate assembly to effect multi-region compression. Such a compression apparatus may be used to apply a compressive force to the active area of the fuel cell stack while still providing sufficient compression in peripheral areas to produce substantially leak proof seals around the internal manifolds.

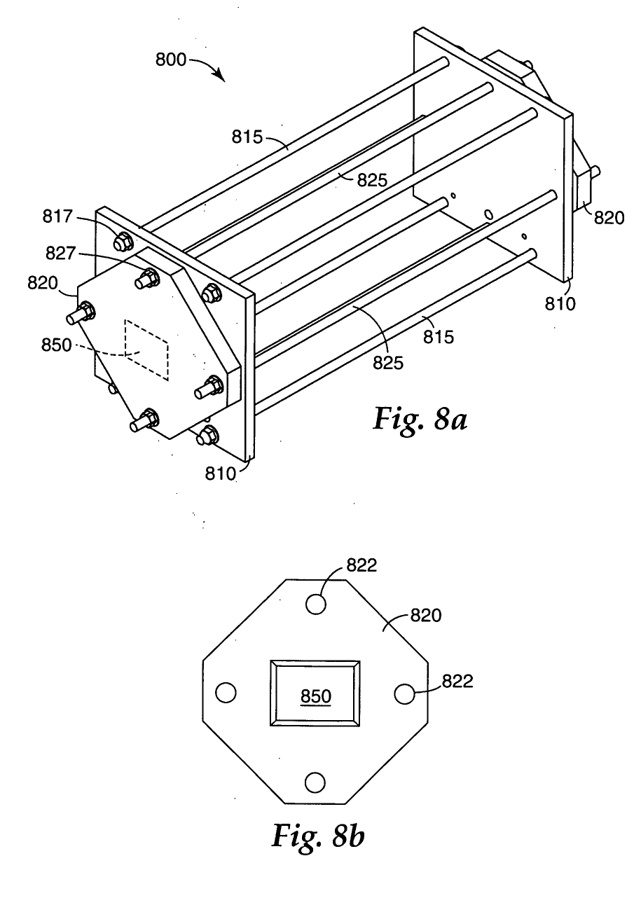

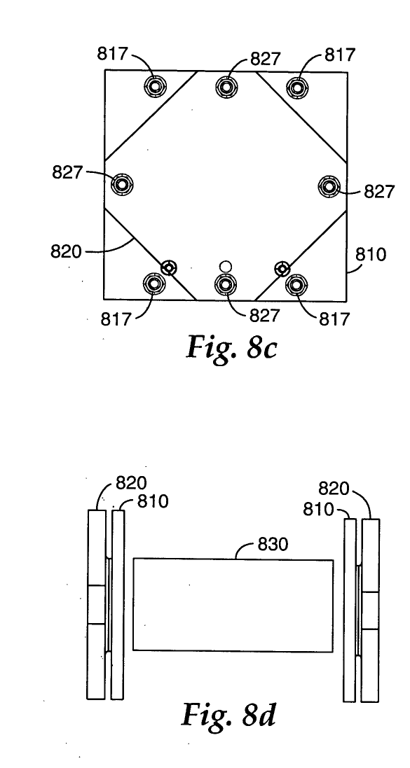

A dual end plate compression assembly 800, in accordance with embodiments of the invention, is shown in FIGS. 8a through 8d. First and second end plates 810, 820 are positioned at each end of a fuel cell stack 830 (FIG. 8d). One set of connecting rods 815 (FIG. 8a) passes through the first end plates 810. A second set of connecting rods 825 passes through both the first and the second end plates 810, 820. In this example, the first end plates 810 are positioned square with respect to the fuel cell stack 830 as is best shown in the end view of the plates 810, 820 illustrated in FIG. 8c. The second plates 820 are rotated from the first end plates 810 by about 45 degrees.

To facilitate preferential compression of the active area of the fuel cell stack 830, one or both of the second end plates 820 may have a raised portion 850 in a central region of the plate 820. FIG. 8b illustrates the inner surface of a second end plate 820 having a raised portion 850. The raised portion 850 may correspond in position to about the relative position of the active areas of the UCAs, for example. The second end plate 820 may be arranged so that the raised region 850 (FIG. 8b) is positioned adjacent the first end plate 810. When the nuts 827 (FIGS. 8a and 8c) of the second plate 820 are tightened, the raised portion 850 produces a force at the center of the first end 810 plate. The force opposes the distortion that would normally occur when the nuts 817 of the first plate 810 are tightened.

The plates may be pulled in independently by the two groups of threaded rods 815, 825 and corresponding nuts 817, 827. The nuts 817, 827 may be evenly torqued, for example, starting with nuts 827 for the second plate 820 and followed by the nuts 817 for the first plate 810. If a second plate 820 has a protruding region 850 in the center, tightening its nuts 827 may be calibrated to produce minimal force at the outer edges of the first plate 810.

The function of the second plate 820 includes assisting the first plate 810 in providing uniform pressure across the active area of the fuel cell by reducing the distortion of the first plate 810 bowing outward, away from the fuel cell stack 830 (FIG. 8d). When the nuts 827 are tightened on the second plate 820, a pressure is applied to the center of the first plate 810. When the nuts 817 are tightened on the first plate 810, a pressure is applied to the outer perimeter of the first plate 810, thus controlling the sealing force applied to the internal manifold seals, and to the active areas of the fuel cells. This procedure enhances even distribution of the compressive forces. Distortion of the second plate 820 does not degrade overall performance of the fuel cell. The thickness of the first and the second plates 810, 820 may be determined by the size and operating conditions, e.g., pressure needed for sealing, etc., of the fuel cell.

The dual end plate assembly can compensate for end plate distortion by exerting an additional force at the center of the fuel cell stack arranged to enhance compression of an active region of the fuel cell stack. The embodiment described in connection with FIGS. 8a-8d provides compression of the peripheral and central regions of the fuel cell stack without requiring holes through the active area of the UCAs. The dual end plate assembly described in this embodiment may be used to reduce end plate thickness, thus reducing weight and material costs.

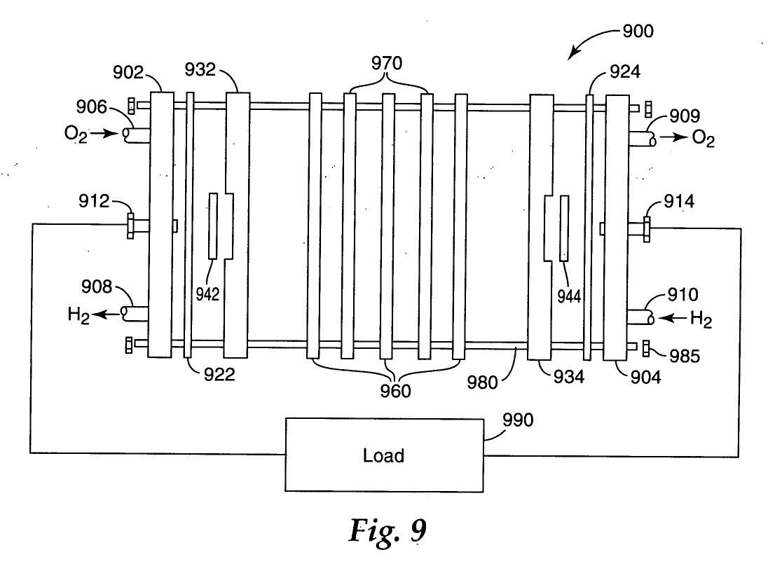

FIG. 9 depicts a simplified fuel cell system that facilitates an understanding of the operation of the fuel cell as a power source. It is understood that any of the current collection system and/or end plate assemblies described above may be employed in a system of the type generally depicted in FIG. 9. The particular components and configuration of the stack shown in FIG. 9 are provided for illustrative purposes only.

The fuel cell system 900 shown in FIG. 9 includes a first and second end plate assemblies configured in accordance with the embodiments discussed above, and disposed at each end of a fuel cell stack. For example, in one implementation, an end plate assembly may include an end plate 902, 904, a current collection/compression bolt 912, 914, a seal 922, 924, and a current collecting plate 942, 944. The fuel cell stack includes flow field plates 932, 934 configured as monopolar flow field plates disposed adjacent the end plates 902, 904. A number of MEAs 960 and bipolar flow field plates 970 are situated between the first and second end plates 902, 904. These MEA and flow field components are preferably of a type described above.

Connecting rods 980 through the end plates 902, 904 may be used to preferentially compress the peripheral regions of the fuel cell stack as the connecting rod nuts 985 are tightened. The central region of the fuel cell stack may be preferentially compressed by tightening the current collection/compression bolts 912, 914. The current collection/compression bolts 912, 914 may also be used to collect current from the fuel cell stack. Current collected from the fuel cell stack is used to power a load 990.

As illustrated in FIG. 9, the fuel cell system 900 includes a first end plate 902 includes a first fuel inlet port 906, which can accept oxygen, for example, and a second fuel outlet port 908, which can discharge hydrogen, for example. A second end plate 904 includes a first fuel outlet port 909, which can discharge oxygen, for example, and a second fuel inlet port 910, which can accept hydrogen, for example. The fuels pass through the stack in a specified manner via the various ports 906, 908, 909, 910 provided in the end plates 902, 904 and manifold ports provided on each of the MEAs 960 and flow field plates 970 (e.g., UCAs) of the stack.

FIGS. 10-13 illustrate various fuel cell systems that may incorporate the fuel cell assemblies described herein and use a fuel cell stack for power generation. The fuel cell system 1000 shown in FIG. 10 depicts one of many possible systems in which a fuel cell assembly as illustrated by the embodiments herein may be utilized.

The fuel cell system 1000 includes a fuel processor 1004, a power section 1006, and a power conditioner 1008. The fuel processor 1004, which includes a fuel reformer, receives a source fuel, such as natural gas, and processes the source fuel to produce a hydrogen rich fuel. The hydrogen rich fuel is supplied to the power section 1006. Within the power section 1006, the hydrogen rich fuel is introduced into the stack of UCAs of the fuel cell stack(s) contained in the power section 1006. A supply of air is also provided to the power section 1006, which provides a source of oxygen for the stack(s) of fuel cells.

The fuel cell stack(s) of the power section 1006 produce DC power, useable heat, and clean water. In a regenerative system, some or all of the byproduct heat can be used to produce steam which, in turn, can be used by the fuel processor 1004 to perform its various processing functions. The DC power produced by the power section 1006 is transmitted to the power conditioner 1008, which converts DC power to AC power for subsequent use. It is understood that AC power conversion need not be included in a system that provides DC output power.

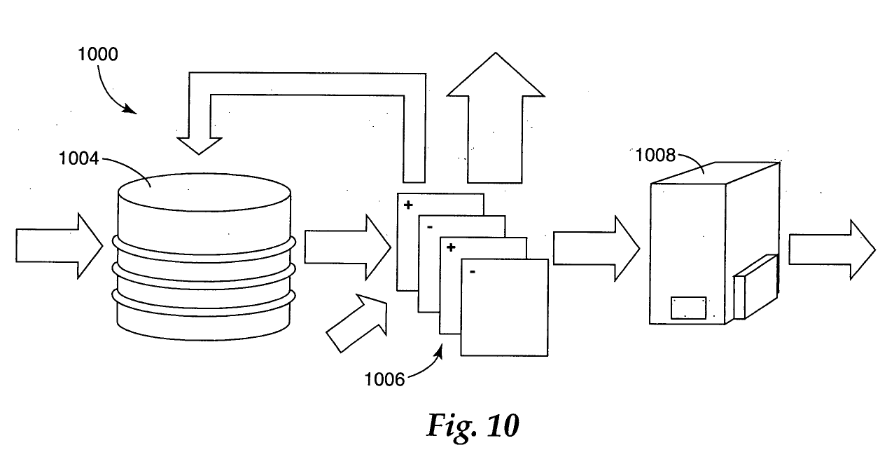

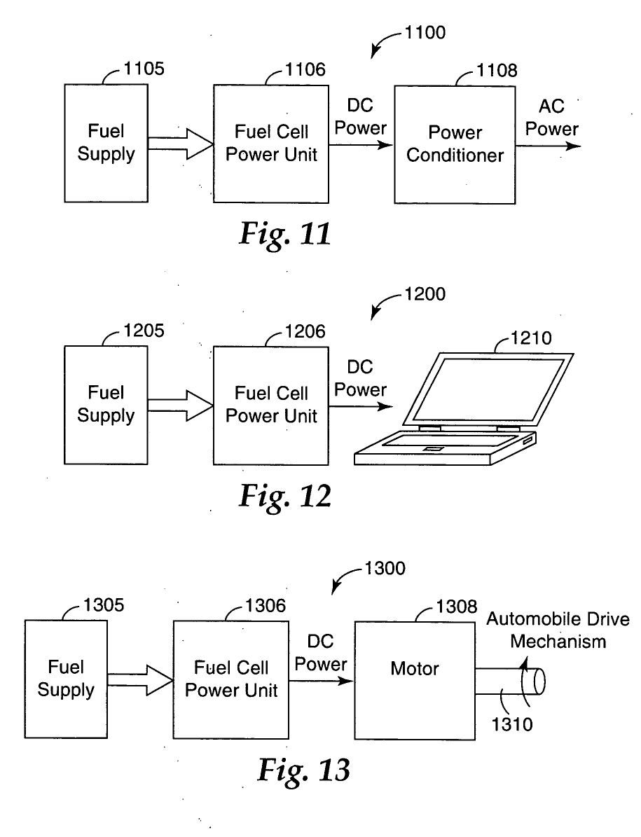

FIG. 11 illustrates a fuel cell power supply 1100 including a fuel supply unit 1105, a fuel cell power section 1106, and a power conditioner 1108. The fuel supply unit 1105 includes a reservoir containing hydrogen fuel that is supplied to the fuel cell power section 1106. Within the power section 1106, the hydrogen fuel is introduced along with air or oxygen into the UCAs of the fuel cell stack(s) contained in the power section 1106.

The power section 1106 of the fuel cell power supply system 1100 produces DC power, useable heat, and clean water. The DC power produced by the power section 1106 may be transferred to the power conditioner 1108, for conversion to AC power, if desired. The fuel cell power supply system 1100 illustrated in FIG. 11 may be implemented as a stationary or portable AC or DC power generator, for example.

In the implementation illustrated in FIG. 12, a fuel cell system uses power generated by a fuel cell power supply to provide power to operate a computer. As described in connection with FIG. 11, fuel cell power supply system includes a fuel supply unit 1205 and a fuel cell power section 1206. The fuel supply unit 1205 provides hydrogen fuel to the fuel cell power section 1206. The fuel cell stack(s) of the power section 1206 produce power that is used to operate a computer 1210, such as a desk top or laptop computer.

In another implementation, illustrated in FIG. 13, power from a fuel cell power supply is used to operate an automobile. In this configuration, a fuel supply unit 1305 supplies hydrogen fuel to a fuel cell power section 1306. The fuel cell stack(s) of the power section 1306 produce power used to operate a motor 1308 coupled to a drive mechanism of the automobile 1310.

The foregoing description of the various embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

1. A fuel cell current collection system, comprising:
a fuel cell stack comprising fuel cells stacked in a predetermined stacking direction; and
an end plate assembly disposed at one end of the fuel cell stack, the end plate assembly comprising:
an end plate; and
a current collector passing through the end plate, electrically coupled to the fuel cell stack, and configured to collect current from the fuel cell stack.

2. The fuel cell current collection system of claim 1, wherein the current collector has a substantially longitudinal orientation with respect to the stacking direction.

3. The fuel cell current collection system of claim 1, wherein the end plate is formed of a non-metallic material.

4. The fuel cell current collection system of claim 1, wherein the end plate is formed of an electrically nonconductive material.

5. The fuel cell current collection system of claim 1, wherein the end plate is formed of a thermally insulating material.

6. The fuel cell current collection system of claim 1, wherein the current collector comprises one or more bolts.

7. The fuel cell current collection system of claim 1, wherein the current collector comprises one or more pins.

8. The fuel cell current collection system of claim 1, wherein the end plate assembly further comprises one or more current collecting plates configured to electrically couple an active area of the fuel cell stack with the current collector.

9. The fuel cell current collection system of claim 8, wherein at least one of the one or more current collecting plates is formed predominantly of a metallic material.

10. The fuel cell current collection system of claim 1, wherein the end plate assembly comprises a current collecting plate configured to fit within a recess of the end plate.

11. The fuel cell current collection system of claim 1, wherein the end plate assembly comprises a current collecting plate configured to fit within a recess formed in a component of the fuel cell stack.

12. The fuel cell current collection system of claim 11, wherein the component of the fuel cell stack comprises a flow field plate of the fuel cell stack.

13. A fuel cell current collection system, comprising:
means for providing a stack of fuel cells arranged between end plates in a predetermined stacking direction; and
means for collecting current from the fuel cell stack, the means for collecting current including a current collector passing through an end plate and electrically coupled to the fuel cell stack.

14. The system of claim 13, wherein the means for collecting current comprises one or more current collecting plates electrically coupling an active area of the fuel cell stack with the current collector.

15. The system of claim 13, wherein the means for collecting current comprises a current collecting disposed in a recessed portion of a component of the fuel cell stack.

16. The system of claim 13, wherein the means for collecting current comprises a current collecting plate disposed in a recessed portion of the end plate.

17. A fuel cell assembly, comprising:
a fuel cell stack comprising fuel cells arranged in a predetermined stacking direction; and
a compression apparatus comprising two or more compression mechanisms, each compression mechanism configured to preferentially compress a separate region of the fuel cell stack.

18. The fuel cell assembly of claim 17, wherein the compression apparatus comprises:
a first compression mechanism configured to preferentially compress an outer region of the fuel cell stack; and
a second compression mechanism configured to preferentially compress an inner region of the fuel cell stack.

19. The fuel cell assembly of claim 17, wherein the compression apparatus comprises:
a first compression mechanism configured to preferentially compress a seal region of the fuel cell stack; and
a second compression mechanism configured to preferentially compress an active region of the fuel cell stack.

20. The fuel cell assembly of claim 17, wherein the compression apparatus comprises:
a first compression mechanism comprising:
first and second outer compression plates respectively disposed at opposing ends of the fuel cell stack; and
one or more outer connecting members extending between the first and the second outer compression plates, the first compression mechanism configured to facilitate preferential compression of a first region of the fuel cell stack; and
a second compression mechanism, comprising:
first and second inner compression plates respectively disposed at opposing ends of the fuel cell stack; and
one or more inner connecting members extending between the first and the second inner compression plates, the second compression mechanism configured to facilitate preferential compression of a second region of the fuel cell stack.

21. The fuel cell assembly of claim 20, wherein:
the one or more outer connecting members comprises a first set of rods extending through peripheral regions of the first and second inner compression plates and the first and second peripheral regions of the second outer compression plates; and
the one or more inner connecting members comprises a second set of rods extending through peripheral regions of the first and second inner compression plates.

22. The fuel cell assembly of claim 20, wherein at least one of the first and the second outer compression plates comprises a protrusion configured to facilitate compression of an inner region of the fuel cell stack.

23. The fuel cell assembly of claim 17, wherein the compression apparatus comprises:
a first compression mechanism comprising:
first and second compression plates respectively disposed at opposing ends of the fuel cell stack; and
one or more connecting members extending between the first and the second compression plates, the first compression mechanism configured to facilitate compression of a peripheral region of the fuel cell stack; and
a second compression mechanism extending through a substantially central portion of at least one of the first and the second compression plates and configured to compress an inner region of the fuel cell stack.

24. The fuel cell assembly of claim 23, wherein the at least one of the first and the second compression plates comprises a threaded hole and the second compression mechanism comprises a bolt extending through the threaded hole.

25. The fuel cell system of claim 17, wherein the two or more compression mechanisms are independently activatable to preferentially compress separate regions of the fuel cell stack.

26. The fuel cell system of claim 17, wherein one of the compression mechanisms is configured to compensate for mechanical distortion of another of the compression mechanisms.

27. A system for compressing a fuel cell stack, comprising:
means for preferentially compressing a first region of the fuel cell stack using a first compression mechanism; and
means for preferentially compressing second region of the fuel cell stack using a second compression mechanism.

28. The system of claim 27, wherein the means for preferentially compressing the first region and the means for compressing the second region are independently activatable.

29. The system of claim 27, further comprising means for compensating for the mechanical distortion of one of the compression mechanisms using another of the compression mechanisms.

30. A system for compressing a fuel cell stack, comprising:
means for preferentially compressing a seal region of the fuel cell stack; and
means for preferentially compressing an active region of the fuel cell stack.

31. A fuel cell system, comprising:
a fuel cell stack comprising fuel cells arranged in a predetermined stacking direction; and
a compression apparatus comprising compression mechanisms configured to preferentially compress separate regions of the fuel cell stack, the compression mechanisms including a current collection/compression mechanism configured to preferentially compress a first region of the fuel cell stack and to collect current from the fuel cell stack.

32. The fuel cell system of claim 31, wherein the current collection/compression mechanism comprises a current collector having a substantially longitudinal orientation with respect to the stacking direction.

33. The fuel cell system of claim 31, wherein the current collection/compression mechanism comprises:
an end plate; and.
a current collector extending through the end plate, electrically coupled to the fuel cell stack, and configured to collect current from the fuel cell stack.

34. The fuel cell system of claim 33, wherein the end plate is formed of a non-metallic material.

35. The fuel cell system of claim 33, wherein the end plate is formed of an electrically nonconductive material.

36. The fuel cell system of claim 33, wherein the end plate is formed of a thermally insulating material.

37. The fuel cell system of claim 33, wherein the current collector comprises one or more bolts.

38. The fuel cell system of claim 33, wherein the current collector comprises one or more pins.

39. The fuel cell system of claim 33, wherein the end plate includes a recess and a current collecting plate is disposed within the recess, the current collecting plate configured to electrically couple an active area of the fuel cell stack with the current collector.

40. The fuel cell system of claim 33, wherein the current collection/compression mechanism further comprises one or more current collecting plates configured to electrically couple an active area of the fuel cell stack with the current collector.

41. The fuel cell system of claim 40, wherein:
the first current collecting plate comprises a recess and is configured to electrically couple an active area of the fuel cell stack with the second current collecting plate; and
the second current collecting plate is disposed within the recess of the first current collecting plate and is configured to electrically couple the first current collecting plate with the current collector.

42. The fuel cell system of claim 41, wherein the first current collecting plate is formed predominantly of graphite.

43. The fuel cell system of claim 41, wherein the second current collecting plate is formed of a metallic material.

44. The fuel cell system of claim 33, wherein the end plate is formed of an electrically non-conductive material.

45. The fuel cell system of claim 31, wherein the compression apparatus comprises:
a peripheral compression mechanism configured to preferentially compress an outer region of the fuel cell stack; and
the current collection/compression mechanism configured to preferentially compress an inner region of the fuel cell stack.

46. The fuel cell system of claim 31, wherein the compression apparatus comprises:
a seal compression mechanism configured to preferentially compress a seal region of the fuel cell stack; and
the current collection/compression mechanism configured to preferentially compress an active region of the fuel cell stack.

47. The fuel cell system of claim 31, wherein the compression apparatus comprises:
a first compression mechanism comprising:
first and second compression plates respectively disposed at opposing ends of the fuel cell stack; and
one or more connecting members extending between the first and the second compression plates, the first compression mechanism configured to facilitate compression of a peripheral region of the fuel cell stack; and
the current collection/compression mechanism extending through a substantially central portion of at least one of the first and the second compression plates and configured to compress an inner region of the fuel cell stack.

48. The fuel cell system of claim 47, wherein the at least one of the first and the second compression plates comprises a threaded hole and the second compression mechanism comprises a bolt extending through the threaded hole.

49. The fuel cell system of claim 31, wherein the compression mechanisms are independently activatable.

50. The fuel cell system of claim 31, wherein at least one of the compression mechanisms is configured to compensate for mechanical distortion of another of the compression mechanisms.

51. The fuel cell system of claim 31, wherein:
the fuel cell system further comprises an automobile; and
the fuel cell stack and the compression apparatus are incorporated in a fuel cell power unit configured to supply power to the automobile.

52. The fuel cell system of claim 31, wherein:
the fuel cell system comprises a computer; and
the fuel cell stack and the compression apparatus are incorporated in a fuel cell power unit configured to supply power to the computer.

53. The fuel cell system of claim 31, wherein the fuel cell stack and the compression apparatus are incorporated in a fuel cell power supply used to supply power to a load.

54. The fuel cell system of claim 31, wherein:
the fuel cell system comprises an auxiliary power system; and
the fuel cell stack and the compression apparatus are incorporated in a fuel cell power unit configured to supply power to the auxiliary power system.

55. The fuel cell system of claim 31, wherein:
the fuel cell system comprises a residential heat and electricity cogeneration unit; and
the fuel cell stack and the compression apparatus are incorporated in a fuel cell power unit configured to supply power to the residential heat and electricity cogeneration unit.

56. A fuel cell assembly, comprising:
means for preferentially compressing a peripheral region of the fuel cell stack using a first compression mechanism; and
means for preferentially compressing an active region of the fuel cell stack and collecting current from the fuel cell stack using a second compression mechanism.

57. A fuel cell end plate, comprising:
a frame; and
a structural element at least partially covering the frame.

58. The fuel cell end plate of claim 57, wherein:
the frame comprises a metallic material; and
the structural element comprises a plastic material.

59. The fuel cell end plate of claim 57, wherein the structural element comprises a substantially electrically nonconductive material.

60. The fuel cell end plate of claim 57, wherein the structural element comprises a substantially thermally insulating material.

61. The fuel cell end plate of claim 57, wherein:
the frame comprises a star-shaped structure; and
the structural element at least partially covers the frame.

62. The fuel cell end plate of claim 61, wherein the star-shaped structure comprises frame members extending radially from a central area.

63. The fuel cell end plate of claim 61, wherein the star-shaped structure comprises:
frame members extending radially from a central area; and
connecting members disposed between the frame members.

64. The fuel cell end plate of claim 57, further comprising a hole in a central region of the end plate.

65. The fuel cell end plate of claim 64, wherein the hole is configured to provide electrical access to the fuel cell stack and facilitate current collection from the fuel cell stack.

66. The fuel cell end plate of claim 64, wherein the hole is configured to provide mechanical access to the fuel cell stack and facilitate compression of a region of the fuel cell stack.

67. The fuel cell end plate of claim 57, wherein;
the frame is formed of a first material; and
the structural element is formed of a second material, the first material having a higher modulus of elasticity than the second material.
